(19) United States
(12) Patent Application Publication
(10) Pub. No.: US 2025/0217246 A1
(43) Pub. Date: Jul. 3, 2025

(54) APPARATUS, SYSTEM, AND METHOD FOR INTERFACING DIES THAT USE INCOMPATIBLE PROTOCOLS

(71) Applicant: Advanced Micro Devices, Inc., Santa Clara, CA (US)

(72) Inventors: Robert Landon Pelt, Austin, TX (US); Nehal Patel, Santa Clara, CA (US); Lu Lu, Beijing (CN); Atul Subhash Athavale, Santa Clara, CA (US); Alexander J. Branover, Boxborough, MA (US); Abin Thomas, Santa Clara, CA (US)

(73) Assignee: Advanced Micro Devices, Inc., Santa Clara, CA (US)

(21) Appl. No.: 18/400,694

(22) Filed: Dec. 29, 2023

(51) Int. Cl. G06F 11/22; G06F 11/14; G06F 13/38

(52) U.S. Cl. CPC G06F 11/2236; G06F 11/1441; G06F 13/387

(57) ABSTRACT

An exemplary apparatus for interfacing dies that use incompatible protocols includes a first die that uses a first protocol, a second die that uses a second protocol, and a die management unit communicatively coupled to both the first die and the second die in an integrated circuit. In some examples, the die management unit is configured to translate at least one message between the first protocol and the second protocol to support communication between the first die and the second die. Various other apparatuses, systems, and methods are also disclosed.

### BACKGROUND

Certain integrated circuits, such as systems on chips (SoCs), often include multiple dies that communicate with one another. In some scenarios, SoC designers and/or engineers can want or need to integrate certain dies that use protocols that are incompatible with one another. Moreover, SoC designers and/or engineers may be unable to access certain information about the innerworkings and/or protocols of certain dies. The instant disclosure, therefore, identifies and addresses a need for additional and improved apparatuses, systems, and methods for interfacing dies that use incompatible protocols.

### BRIEF DESCRIPTION OF THE DRAWINGS

The accompanying drawings illustrate a number of exemplary implementations and are a part of the specification. Together with the following description, these drawings demonstrate and explain various principles of the instant disclosure.

FIG. 1 is a block diagram of an exemplary apparatus for interfacing dies that use incompatible protocols according to one or more implementations of this disclosure.

FIG. 2 is a block diagram of an exemplary apparatus for interfacing dies that use incompatible protocols according to one or more implementations of this disclosure.

FIG. 3 is a block diagram of an exemplary apparatus for interfacing dies that use incompatible protocols according to one or more implementations of this disclosure.

FIG. 4 is a block diagram of an exemplary system for interfacing dies that use incompatible protocols according to one or more implementations of this disclosure.

FIG. 5 is a block diagram of an exemplary system for interfacing dies that use incompatible protocols according to one or more implementations of this disclosure.

FIG. 6 is a flowchart of an exemplary method for interfacing dies that use incompatible protocols according to one or more implementations of this disclosure.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the instant disclosure covers all modifications, equivalents, and alternatives falling within the scope of the appended claims.

### DETAILED DESCRIPTION OF EXEMPLARY IMPLEMENTATIONS

The present disclosure describes various apparatuses, systems, and methods for interfacing dies that use incompatible protocols. In some examples, a system on a chip (SoC) designer and/or engineer can want or need to incorporate, into an SoC, a third-party die whose protocol differs from those used by the designer's and/or engineer's proprietary dies. Additionally or alternatively, the SoC designer and/or engineer can want and/or need to incorporate, into an SoC, a die (whether proprietary or third-party) whose innerworkings and/or protocols are unknown to and/or abstracted from the designer and/or engineer. Either way, the SoC designer and/or engineer can integrate and/or incorporate such a die into the SoC by relying on a die management unit that facilitates and/or supports interfacing dies that use different and/or incompatible protocols.

For example, the die management unit can discover and/or learn a die's protocol and/or commands. Additionally or alternatively, the die management unit can translate and/or convert messages formatted in the die's protocol to another protocol used by another die or vice versa. Accordingly, the die management unit can enable the SoC designer and/or engineer to incorporate a die whose innerworkings and/or protocols are unknown and/or a die whose protocol differs from those used by other dies into an SoC. As a result, the SoC designer and/or engineer can have more tools and/or equipment at their disposal for the SoC design. In other words, the SoC designer and/or engineer can be less limited in the SoC design by unknowns and/or differences among the dies.

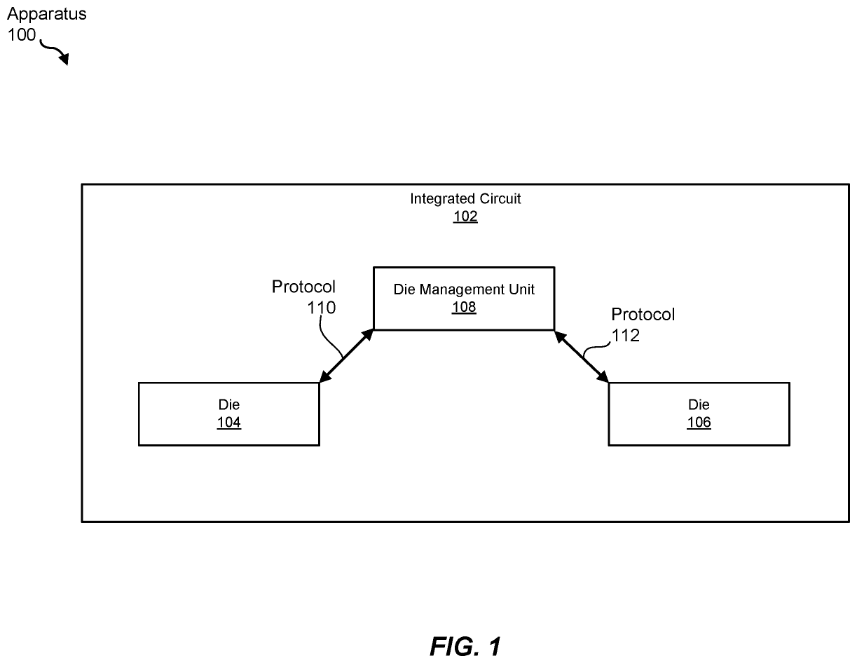

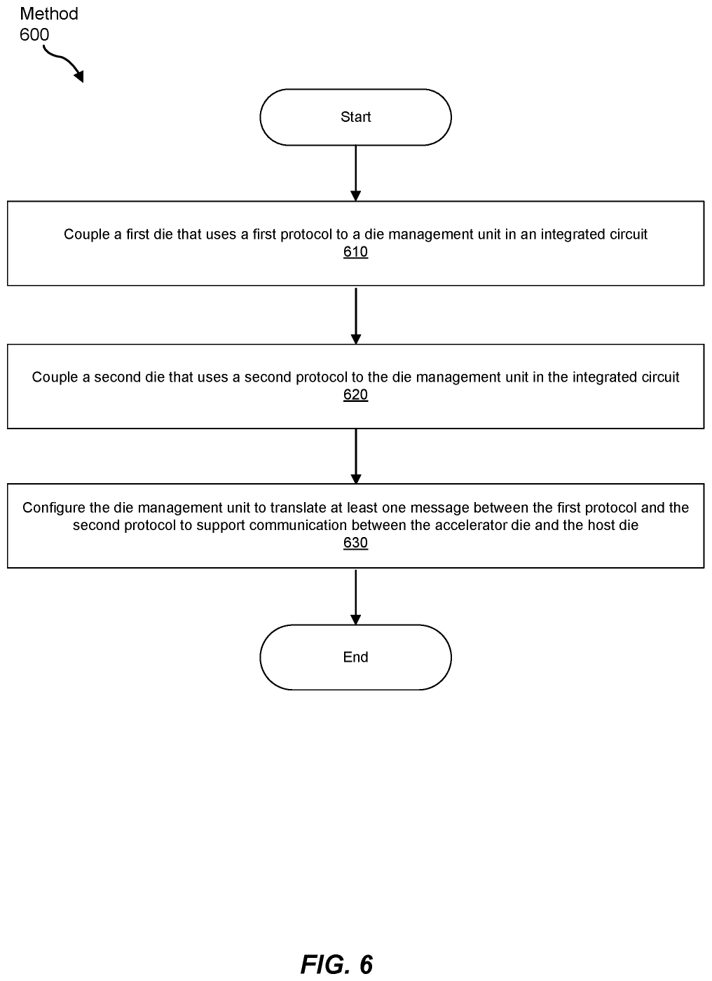

The following will provide, with reference to FIGS. 1-5, detailed descriptions of exemplary apparatuses, devices, systems, and/or corresponding implementations for interfacing dies that use incompatible protocols. Detailed descriptions of an exemplary method for interfacing dies that use incompatible protocols will be provided in connection with FIG. 6.

FIG. 1 illustrates an exemplary apparatus 100 for interfacing dies that use incompatible protocols. As illustrated in FIG. 1, exemplary apparatus 100 can include and/or represent dies 104 and 106 communicatively coupled to a die management unit 108 within an integrated circuit 102. In some examples, dies 104 and 106 can use, operate, and/or support different and/or incompatible communication protocols relative to one another. For example, die 104 can use, operate, and/or support a protocol 110, and die 106 can use, operate, and/or support a protocol 112.

In some examples, protocol 110 can constitute and/or represent an industry standard. For example, protocol 110 can constitute and/or represent peripheral component interconnect express (PCIe). Additional examples of protocol 110 include, without limitation, compute express link (CXL) protocol, universal serial bus (USB) protocol, advanced extensible interface (AXI) protocol, coherent hub interface (CHI) protocol, inter-integrated circuit (I²C) protocol, serial peripheral interface (SPI) protocol, improved inter-integrated circuit (I³C) protocol, variations or combinations of one or more of the same, and/or any other suitable protocol.

In some examples, protocol 112 can differ from and/or be incompatible with protocol 110. For example, protocol 112 can be custom and/or proprietary for the designer and/or manufacturer of die 106. Additionally or alternatively, protocol 112 is unknown to the designer and/or manufacturer of integrated circuit 102.

In some examples, die 106 can constitute and/or represent a third-party component that the designer and/or manufacturer of integrated circuit 102 plans to interface with die 104 in integrated circuit 102. Additionally or alternatively, die 106 can constitute and/or represent a proprietary component designed, developed, and/or produced by a different department and/or team within the same company that designed, developed, and/or produced die 104 and/or integrated circuit 102.

In some examples, die 104 lacks support for and/or is unable to communicate via protocol 112. Additionally or alternatively, die 106 lacks support for and/or is unable to communicate via protocol 110.

In some examples, die management unit 108 can provide, facilitate, and/or support communication between dies 104 and 106 despite their different and/or incompatible protocols. In one example, die management unit 108 can translate and/or convert messages between protocols 110 and 112 for dies 104 and 106. By doing so, die management unit 108 can enable dies 104 and 106 to communicate with one another in integrated circuit 102.

In some examples, die management unit 108 can be programmed and/or configured with knowledge and/or intelligence about protocol 110 and/or protocol 112. For example, die management unit 108 can be programmed and/or configured with a table and/or mapping populated with knowledge and/or intelligence about the relationships between protocols 110 and 112. In this example, the table and/or mapping can facilitate converting messages between protocol 110 and protocol 112. Accordingly, die management unit 108 can translate and/or convert messages between protocol 110 and protocol 112 by applying the table and/or mapping.

Additionally or alternatively, die management unit 108 can discover and/or learn about protocol 110 and/or protocol 112 during initialization and/or operation. For example, die management unit 108 can be programmed and/or configured to request and/or obtain information about protocol 112 from die 106. In this example, die management unit 108 can determine and/or identify certain relationships between protocols 110 and 112 based at least in part on the information about protocol 112 obtained from die 106. In one example, die management unit 108 can then distill these relationships into a table and/or mapping that facilitates converting messages between protocol 110 and protocol 112.

In some examples, dies 104 and 106 can each include and/or represent a small, diced piece of semiconductor material. Additionally or alternatively, dies 104 and 106 can each include and/or represent chiplets. In one example, dies 104 and 106 can each include and/or contain one or more circuits that consist of various electrical and/or electronic components (such as resistors, capacitors, diodes, and/or transistors).

In some examples, dies 104 and 106 can each include and/or represent any type or form of circuitry disposed on and/or integrated into a die. In one example, die 104 can include and/or represent a native host, and die 106 can include and/or represent an accelerator, such as an artificial intelligence (AI) accelerator and/or a hardware-accelerated neural network. Examples of dies 104 and 106 include, without limitation, physical processors, central processing units (CPUs), microprocessors, microcontrollers, field-programmable gate arrays (FPGAs), application-specific integrated circuits (ASICs), parallel accelerated processors, tensor cores, integrated circuits, chiplets, accelerators, portions of one or more of the same, variations or combinations of one or more of the same, and/or any other suitable dies.

In some examples, die management unit 108 can include and/or represent any type or form of hardware-implemented component, device, and/or feature capable of translating between protocols used by dies. In one example, die management unit 108 can include and/or represent a separate die in addition to dies 104 and 106. Examples of die management unit 108 include, without limitation, physical processors, CPUs, microprocessors, microcontrollers, FPGAS, ASICs, parallel accelerated processors, tensor cores, integrated circuits, chiplets, portions of one or more of the same, variations or combinations of one or more of the same, and/or any other suitable die management unit.

In some examples, integrated circuit 102 can include and/or represent any type or form of circuit package that contains and/or houses multiple dies. Additionally or alternatively, integrated circuit 102 can include and/or represent any type or form of circuitry that processes, converts, and/or transforms input, data, or signals in one way or another. In one example, integrated circuit 102 can include and/or represent multiple circuits that are distributed across multiple dies and/or utilized by a larger computing system. Examples of integrated circuit 102 include, without limitation, SoCs, ASICs, physical processors, parallel accelerated processors, tensor cores, portions of one or more of the same, variations or combinations of one or more of the same, and/or any other suitable integrated circuits.

In some examples, dies 104 and 106, die management unit 108, and/or integrated circuit 102 can be created, manufactured, and/or produced by a variety of fabrication processes. Examples of such fabrication processes include, without limitation, lamination, lithography, etching, deposition, chemical mechanical planarization, oxidation, ion implantation, photolithography, diffusion, combinations or variations of one or more of the same, and/or any other suitable fabrication processes. Various components can be laminated, etched, attached, and/or otherwise coupled to dies 104 and 106, die management unit 108, and/or integrated circuit 102.

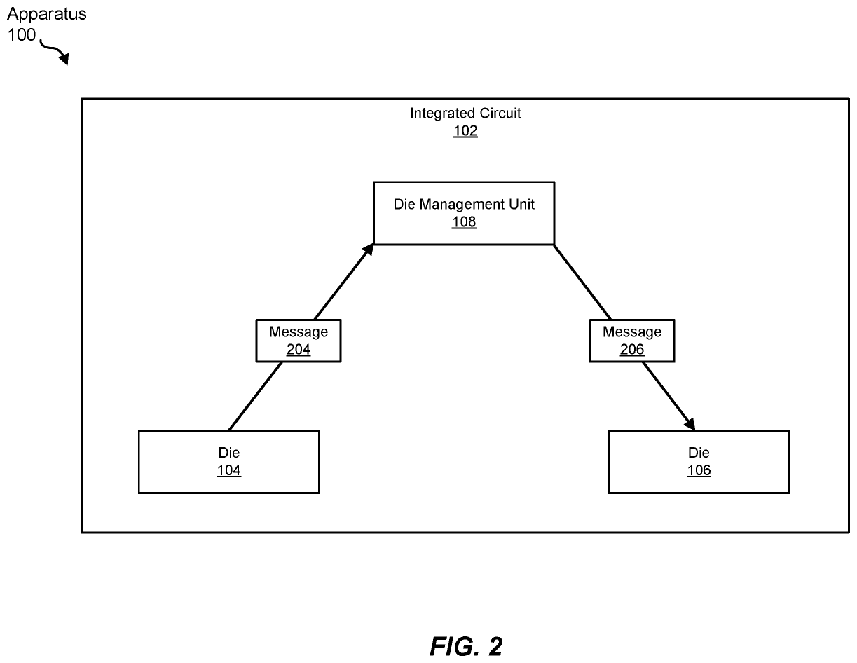

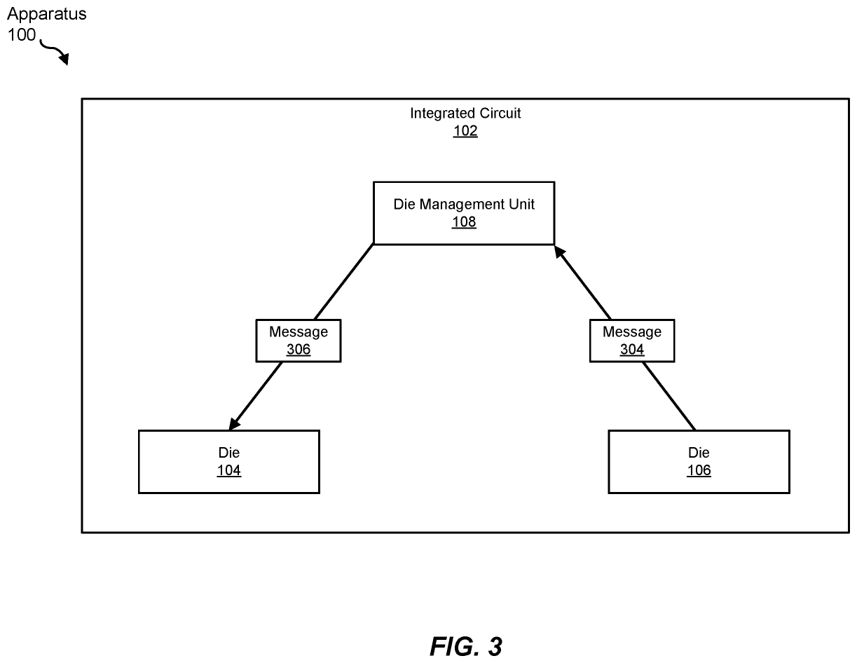

FIGS. 2 and 3 illustrates exemplary implementations of apparatus 100 for interfacing dies that use incompatible protocols. In some examples, apparatus 100 in FIGS. 2 and 3 can include and/or represent certain components and/or features that perform and/or provide functionalities that are similar and/or identical to those described above in connection with FIG. 1. As illustrated in FIGS. 2 and 3, apparatus 100 can include and/or represent dies 104 and 106 in communication with one another via die management unit 108.

In some examples, die 104 can send and/or provide a message 204 formatted in protocol 110 to die 106 via die management unit 108. For example, die management unit 108 can receive message 204 from die 104 and then translate and/or convert message 204 to a version that is compatible and/or complies with protocol 112. Additionally or alternatively, die management unit 108 can create a message 206 that constitutes and/or represents a translation and/or conversion of message 204. In this example, message 206 can be compatible and/or comply with protocol 112. Die management unit 108 can send and/or provide message 206 to die 106 to facilitate and/or support communication with die 106 on behalf of die 104.

In some examples, die 106 can send and/or provide a message 304 formatted in protocol 112 to die 106 via die management unit 108. For example, die management unit 108 can receive message 304 from die 106 and then translate and/or convert message 304 to a version that is compatible and/or complies with protocol 110. Additionally or alternatively, die management unit 108 can create a message 306 that constitutes and/or represents a translation and/or conversion of message 304. In this example, message 306 can be compatible and/or comply with protocol 110. Die management unit 108 can send and/or provide message 306 to die 104 to facilitate and/or support communication with die 104 on behalf of die 106.

In some examples, these messages can include and/or represent various data, information, and/or content corresponding to die 104 and/or die 106. Examples of such data, information, and/or content include, without limitation, commands, instructions, configuration information, settings, control information, errors, memory data, events, portions of one or more of the same, variations or combinations of one or more of the same, and/or the like.

In some examples, die 106 can be abstracted and/or isolated from the native host configuration, commands, and/or controls of die 104. For example, die management unit 108 can provide, to die 106, services that do not rely on the host native protocols and/or procedures. In this example, certain messages translated and/or converted by die management unit 108 for dies 104 and 106 can be directed to and/or involved in providing these services. In one example, such a service can include and/or represent reliability, availability, and serviceability (RAS) events and/or features. Additional examples of such services include, without limitation, security services, power services, thermal services, management services, bootup services, reset services, configuration services, portions of one or more of the same, variations or combinations of one or more of the same, and/or any other suitable services.

In some examples, RAS events can include and/or represent occurrences and/or probabilities indicative of whether die 104 and/or die 106 are producing the correct and/or expected outputs. In one example, such occurrences and/or probabilities can be measured and/or represented as mean times between failures (MTBFs). In this example, if a measured MTBF satisfies a given threshold, then die 104 and/or die 106 can implement corrections to address and/or repair one or more hardware faults in runtime.

In some examples, RAS events can include and/or represent occurrences and/or probabilities indicative of whether die 104 and/or die 106 are or will be operational at any given time. In one example, such occurrences and/or probabilities can be measured as a percentage of downtime over a given period. In this example, if the percentage of downtime satisfies a given threshold, then die 104 and/or die 106 can implement corrections to address and/or repair one or more hardware faults in runtime.

In some examples, RAS events can include and/or represent indications of the difficulty and/or speed with which hardware faults can be corrected. In one example, such indications can be measured and/or represented as mean times between repairs (MTBRs). Additionally or alternatively, if a measured MTBR satisfies a given threshold, then die 104 and/or die 106 can implement corrections to address and/or repair one or more hardware faults in runtime.

Additionally or alternatively, die 104 can be abstracted and/or isolated from the accelerator configuration, commands, and/or controls of die 106. For example, die management unit 108 can provide, to die 104, services that do not rely on the accelerator protocols and/or procedures. In this example, certain messages translated and/or converted by die management unit 108 for dies 104 and 106 can be directed to and/or involved in providing these services. In one example, such a service can include and/or represent monitoring and/or reporting of certain events and/or observations (e.g., temperature, power consumption, errors and/or faults, etc.). Additional examples of such services include, without limitation, security services, power services, thermal services, management services, bootup services, reset services, configuration services, portions of one or more of the same, variations or combinations of one or more of the same, and/or any other suitable services.

In some examples, die management unit 108 can facilitate, provide, and/or support the initialization and/or configuration of die 106 in connection with die 104. In such examples, die management unit 108 can enable die 106 to complete the initialization and/or configuration even though die 106 is unaware of and/or blind to the native host protocols and/or procedures of die 104.

In some examples, die management unit 108 can facilitate and/or support minimizing and/or optimizing the power states and/or power consumption of die 104 and/or die 106. For example, die management unit 108 can maximize the amount of time in which die 106 remains inactive and/or operates in a low power state. Additionally or alternatively, die management unit 108 can maximize the amount of time in which die 104 remains inactive, spends offline, and/or operates in a low power state. In one example, die management unit 108 can configure and/or direct die 104 to remain inactive and/or offline while servicing requests from die 106.

In some examples, die management unit 108 can abstract and/or isolate die 104 from die 106 after die 106 experiences an error and/or fault. For example, die 106 can experience an error and/or fault. In this example, die management unit 108 can detect the error and/or fault experienced by die 106. In response to detecting the faulty die, die management unit 108 can isolate die 104 from die 106 and/or notify die 104 of the error and/or fault.

In some examples, die management unit 108 can receive a message from die 104 in response to the error and/or fault. In one example, the message can include and/or represent a command intended to repair die 106 and/or initiate a recovery of die 106 in view of the error and/or fault. In this example, die management unit 108 can translate and/or convert the message into a format that complies with protocol 112. Die management unit 108 can then send the translated version of the message to die 106 to repair and/or initiate a recovery of the same.

In some examples, die 106 is irreparable and/or unable to recover from the error and/or fault despite having received the translated version of the message. In one example, die management unit 108 can attempt to repair die 106 due at least in part to the translated version of the message failing to do so successfully. For example, die management unit 108 can execute and/or initiate a die-specific reset event that causes die 106 to reset and/or reboot. In this example, the die-specific reset event affects only and/or is limited to resetting and/or rebooting die 106, as opposed to die 104 and/or any other components of integrated circuit 102. The die-specific reset event can effectively repair die 106 and/or enable die 106 to recover from the error and/or fault.

In some examples, die 106 is irreparable and/or unable to recover from the error and/or fault despite die management unit 108 attempting to execute and/or initiate a die-specific event. In one example, die management unit 108 can attempt to repair die 106 in another way due at least in part to the die-specific event failing to do so successfully. For example, die management unit 108 can execute and/or initiate a global reset event that causes all of integrated circuit 102, including die 106, to reset and/or reboot. In this example, the global reset event can effectively repair die 106 and/or enable die 106 to recover from the error and/or fault.

In some examples, die management unit 108 can modify the power states of die 104 and/or die 106 in response to certain events and/or conditions. In one example, die management unit 108 can maintain die 104 and/or die 106 in a low power state as much as possible to limit power consumption. For example, this low power state can constitute and/or represent the default power mode for die 104 and/or die 106. In this example, die management unit 108 can awaken and/or elevate the power state (e.g., to a normal or high power state) of die 104 and/or die 106 in response to certain events and/or conditions. For example, die management unit 108 can detect a message destined for die 104 from die 106 and then awaken die 104 to receive a translated version of the message and/or perform one or more actions in response to the same. Additionally or alternatively, die management unit 108 can detect a message destined for die 106 from die 104 and then awaken die 106 to receive a translated version of the message and/or perform one or more actions in response to the same.

In some examples, die management unit 108 can detect and/or receive a request formatted in protocol 110 from die 104. In one example, this request can be configured and/or intended to modify the power state of die 106. In this example, die management unit 108 can translate and/or convert the request from the protocol 110 to protocol 112. Die management unit 108 can direct die 106 to modify and/or implement a specific power state based at least in part on the translated request.

As a specific example, die 104 can use and/or apply advanced configuration and power interface (ACPI) power states, but die 106 can use and/or apply custom and/or proprietary power states that differ from the ACPI power states. In this example, the request received by die management unit 108 can identify and/or indicate a specific ACPI power state to apply and/or implement on die 106. However, because die 106 uses the custom and/or proprietary power states, die 106 may be unable to interpret the ACPI power state identified and/or indicated in the request. As a result, die management unit 108 can translate and/or convert the request to identify and/or indicate the custom and/or proprietary power state of die 106 that corresponds to the ACPI power state. Die management unit 108 can then send the translated and/or converted request to die 106 to direct die 106 to implement the corresponding custom and/or proprietary power state.

In some examples, die management unit 108 can modify the security states (e.g., low security, moderate security, and/or high security) of die 104 and/or die 106 in response to certain events and/or conditions. In one example, dies 104 and 106 can apply and/or implement different security states relative to one another. For example, die 104 can apply and/or implement various security states (e.g., more than two different security states), and die 106 can apply and/or implement only two different security states. In this example, die management unit 108 can be configured and/or programmed to map each of the various security states of die 104 to one of the two different security states of die 106. Accordingly, die management unit 108 can map the security states of die 104 to the security states of die 106.

In some examples, die management unit 108 can detect and/or receive a request formatted in protocol 110 from die 104. In one example, this request can be configured and/or intended to modify the security state of die 106. In this example, die management unit 108 can translate and/or convert the request from the protocol 110 to protocol 112 based at least in part on the mapping of the security states of die 104 to the security states of die 106. Die management unit 108 can direct die 106 to modify and/or implement a specific security state based at least in part on the translated request.

In some examples, die management unit 108 can translate and/or convert RAS events in connection with die 104 and/or die 106, thereby enabling the other to interpret such RAS events. In one example, dies 104 and 106 can apply and/or implement different RAS formatting relative to one another. For example, die 104 can apply and/or implement an x86 machine check architecture (MCA) format for RAS events and/or messages, and die 106 can apply and/or implement a custom and/or proprietary format for RAS events and/or messages. In this example, die management unit 108 can translate and/or convert RAS events and/or messages originating from die 106 to the x86 MCA format for interpretation by die 104. Die management unit 108 can then notify die 104 of such RAS events and/or messages originating from die 106 via the x86 MCA format.

In other examples, die 104 can apply and/or implement reduced instruction set computer (RISC) architectures for RAS events and/or messages, and die 106 can apply and/or implement a custom and/or proprietary format for RAS events and/or messages. For example, die 104 can apply and/or implement an advanced RISC machine (ARM) format for RAS events and/or messages, and die 106 can apply and/or implement a custom and/or proprietary format for RAS events and/or messages. In this example, die management unit 108 can translate and/or convert RAS events and/or messages originating from die 106 to the ARM format for interpretation by die 104. Die management unit 108 can then notify die 104 of such RAS events and/or messages originating from die 106 via the x86 ARM format.

In some examples, die management unit 108 can translate and/or convert thermal control commands and/or messages between protocol 110 and protocol 112 for die 104 and die 106, respectively. In one example, dies 104 and 106 can format and/or interpret thermal control commands in different ways relative to one another. For example, die 104 can apply and/or implement a standard format for thermal control commands, and die 106 can apply and/or implement a custom and/or proprietary format for thermal control commands. In this example, die 106 is unable to interpret thermal control commands that follow the standard format of die 104. As a result, die management unit 108 can translate and/or convert thermal control commands originating from die 104 to the custom and/or proprietary format of die 106. Die management unit 108 can then direct die 106 to modify and/or implement one or more thermal settings via the translated thermal control commands.

In some examples, die management unit 108 and die 104 and/or die 106 can communicate via a predefined interface and/or application programming interfaces (APIs). In one example, the predefined interface and/or APIs can use and/or rely on a set of addressable components included on die 104 and/or die 106. For example, the addressable components can include and/or represent a set of standard and/or configurable storage units. As a specific example, die management unit 108 can communicate certain messages and/or events to die 106 via a set of storage units that support the APIs and/or standard messages. Additionally or alternatively, the addressable components can include and/or represent sub-circuits that are differentiated from one another by assigned addresses (e.g., 7-bit discrete addresses). In certain implementations, die management unit 108 can communicate with certain sub-circuits included in die 104 and/or die 106 by exchanging messages directed to and/or originating from the addresses assigned to such sub-circuits.

In some examples, die management unit 108 can direct die 104 to operate in a low power state. Additionally or alternatively, die management unit 108 can detect that die 104 is operating in a low power state. In one example, die management unit 108 can detect an event (e.g., a message and/or request) in connection with die 106. In this example, if the event implicates die 104 and/or necessitates assistance or attention from die 104, die management unit 108 can direct die 104 to implement a higher power state to enable die 104 to redress and/or handle the event. Upon implementation of the higher power state by die 104, die management unit 108 can notify die 104 of the event.

In another example, if the event does not implicate die 104 and/or does not necessitate assistance or attention from die 104, die management unit 108 can refuse to notify die 104 of the event. In this example, die management unit 108 can maintain die 104 in the low power state due at least in part to the event not implicating die 104 and/or not necessitating assistance or attention from die 104. Accordingly, die management unit 108 can allow die 104 to remain in the low power state despite the event detected in connection with die 106.

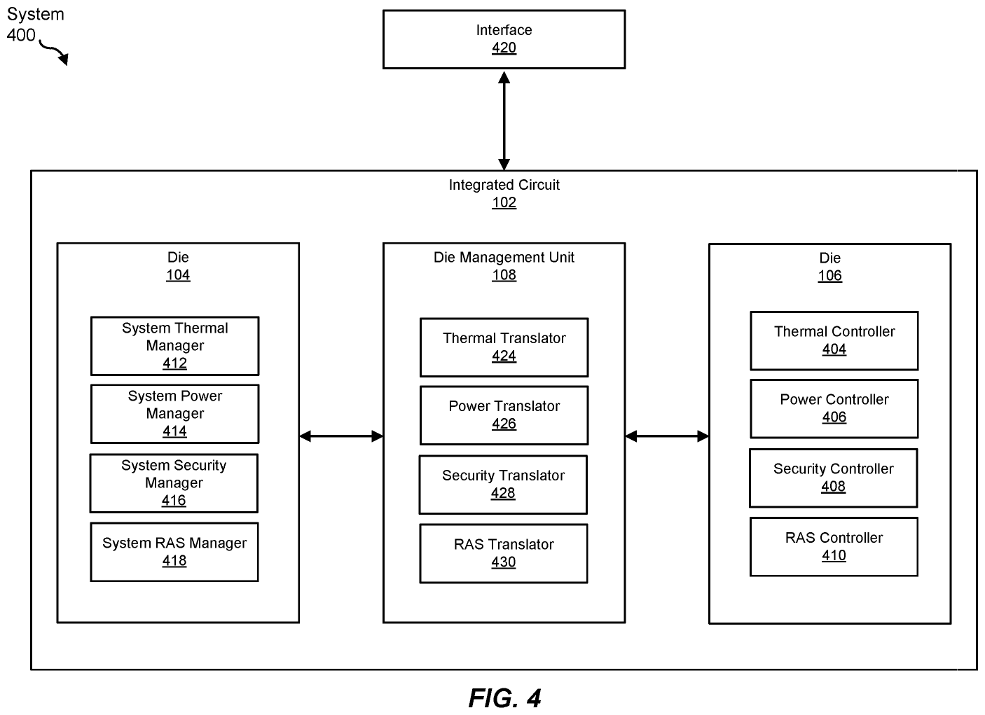

FIG. 4 illustrates an exemplary system 400 for interfacing dies that use incompatible protocols. In some examples, system 400 can include and/or represent certain components and/or features that perform and/or provide functionalities that are similar and/or identical to those described above in connection with any of FIGS. 1-3. As illustrated in FIGS. 4, system 400 can include and/or represent integrated circuit 102 communicatively coupled to an interface 420. In one example, integrated circuit 102 can include and/or represent dies 104 and 106 in communication with one another via die management unit 108.

In some examples, die 104 can include and/or represent various system managers, such as a system thermal manager 412, a system power manager 414, a system security manager 416, and/or a system RAS manager 418. In such examples, die 106 can include and/or represent a thermal controller 404, a power controller 406, a security controller 408, and/or a RAS controller 410. In one example, die management unit 108 can include and/or represent a thermal translator 424, a power translator 426, a security translator 428, and/or a RAS translator 430.

In some examples, the system managers incorporated on die 104 can be configured and/or programed to direct and/or manage the controllers incorporated on die 106. Due to the incompatibility of protocols 110 and 112, die management unit 108 can translate and/or convert messages, commands, or events originating from the system managers incorporated on die 104 to comply with the formatting of protocol 112 for interpretation by die 106. Similarly, die management unit 108 can translate and/or convert messages, commands, or events originating from the controllers incorporated on die 106 to comply with the formatting of protocol 110 for interpretation by die 104.

In some examples, the system managers can include and/or represent certain hardware devices and/or sub-circuits implemented on die 104. Additionally or alternatively, the system managers can include and/or represent software and/or code executed by certain hardware devices and/or sub-circuits implemented on die 104.

In some examples, interface 420 can include and/or represent an input device that provides input to integrated circuit 102. In one example, the input can cause one or more components of integrated circuit 102 to perform one or more actions and/or modify one or more settings. Examples of such an input device include, without limitation, a mouse, a camera, a stylus, a keyboard, a touchpad, a touchscreen, a microphone, a sensor, a controller, communication interface, antenna, receiver, port, combinations or variations of one or more of the same, and/or any other suitable input device.

In some examples, interface 420 can include and/or represent an output device to which integrated circuit 102 provides output. In one example, the output can cause one or more interface 420 to perform one or more actions and/or modify one or more settings. Examples of such an output device include, without limitation, a monitor, a display, a speaker, a motor, a haptic device, an actuator, communication interface, antenna, transmitter, port, combinations or variations of one or more of the same, and/or any other suitable output device.

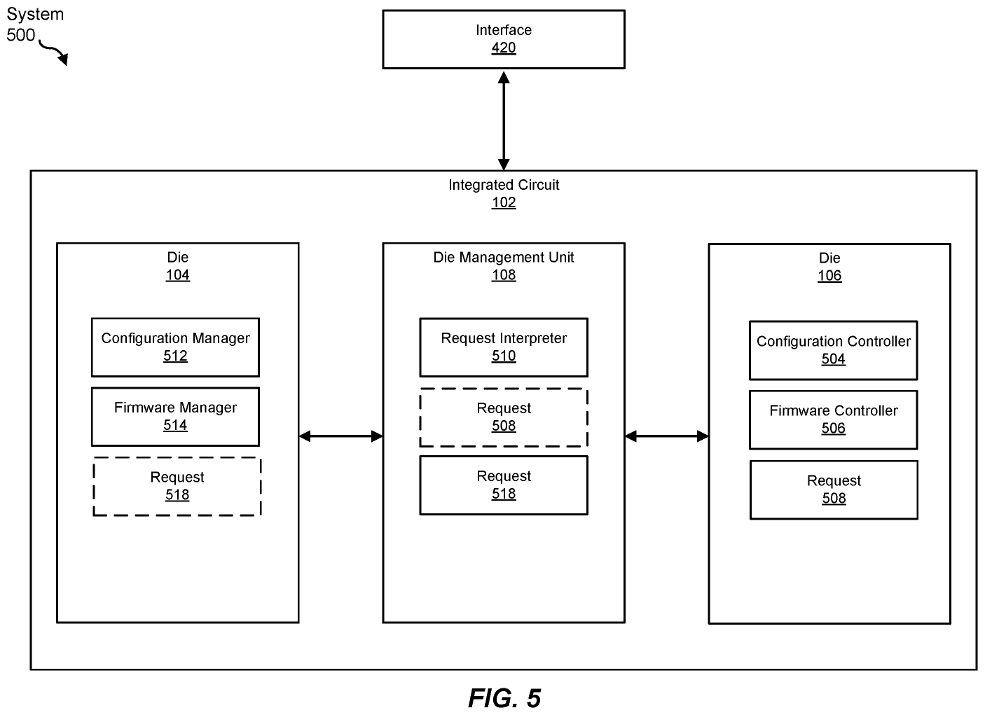

FIG. 5 illustrates an exemplary system 500 for interfacing dies that use incompatible protocols. In some examples, system 500 can include and/or represent certain components and/or features that perform and/or provide functionalities that are similar and/or identical to those described above in connection with any of FIGS. 1-4. As illustrated in FIGS. 5, system 500 can include and/or represent integrated circuit 102 communicatively coupled to an interface 420. In one example, integrated circuit 102 can include and/or represent dies 104 and 106 in communication with one another via die management unit 108.

In some examples, die 104 can include and/or represent a configuration manager 512 and/or a firmware manager 514. In such examples, die 106 can include and/or represent a configuration controller 504 and/or a firmware controller 506. In one example, die management unit 108 can include and/or represent request interpreter 510 that interprets and/or converts requests received from either die 104 and/or die 106.

In some examples, configuration controller 504 and/or firmware controller 506 can include and/or represent any type or form of component, device, and/or feature capable of storing, assigning, and/or providing configurations and/or firmware, respectively. In one example, configuration controller 504 and/or firmware controller 506 can each include and/or represent one or more CPUs and/or microcontrollers. Additional examples of configuration controller 504 and/or firmware controller 506 include, without limitation, physical processors, microprocessors, microcontrollers, FPGAs, ASICs, parallel accelerated processors, tensor cores, integrated circuits, chiplets, portions of one or more of the same, variations or combinations of one or more of the same, and/or any other suitable controller.

In some examples, die management unit 108 can request certain assets from die 104 or die 106 on behalf of one another. For example, to support initializing die 106, die management unit 108 can request an asset from die 104. In this example, the asset can be intended for use by die 106. In one example, the asset can include and/or represent firmware and/or a specific configuration.

In one example, die 106 can generate a request 508 formatted in protocol 112 for one or more assets (e.g., firmware and/or a configuration) from die 104. In this example, die management unit 108 can receive request 508 from die 106 and then interpret the contents of request 508 for translation and/or conversion to protocol 110. Die management unit 108 can generate a request 518 formatted in protocol 110 and then send request 518 to die 104 on behalf of die 106.

In one example, die 104 can retrieve firmware from firmware manager 514 and/or a configuration from configuration manager 512 in response to request 518. In this example, die 104 can provide the firmware and/or configuration to die management unit 108 in satisfaction of request 518. Die management unit 108 can then provide the firmware and/or configuration to die 106 in satisfaction of request 508. Upon receiving the firmware and/or configuration from die management unit 108, die 106 can apply and/or implement the firmware and/or configuration via firmware controller 506 and/or configuration controller 504, respectively.

In some examples, the various devices and/or systems described in connection with FIGS. 1-5 can include and/or represent one or more additional circuits, components, and/or features that are not necessarily illustrated and/or labeled in FIGS. 1-5. For example, integrated circuit 102 can also include and/or represent additional analog and/or digital circuitry, dies, onboard logic, transistors, resistors, capacitors, diodes, inductors, switches, registers, flipflops, connections, traces, buses, semiconductor (e.g., silicon) devices and/or structures, processing devices, storage devices, circuit boards, packages, substrates, housings, combinations or variations of one or more of the same, and/or any other suitable components that facilitate and/or support interfacing dies that use incompatible protocols. In certain implementations, one or more of these additional circuits, components, devices, and/or features can be inserted and/or applied between any of the existing circuits, components, and/or devices illustrated in FIGS. 1-5 consistent with the aims and/or objectives provided herein. Accordingly, the electrical and/or communicative couplings described with reference to FIGS. 1-5 can be direct connections with no intermediate components, devices, and/or nodes or indirect connections with one or more intermediate components, devices, and/or nodes.

In some examples, the phrase “to couple” and/or the term “coupling”, as used herein, can refer to a direct connection and/or an indirect connection. For example, a direct coupling between two components can constitute and/or represent a coupling in which those two components are directly connected to each other by a single node that provides electrical continuity from one of those two components to the other. In other words, the direct coupling can exclude and/or omit any additional components between those two components.

Additionally or alternatively, an indirect coupling between two components can constitute and/or represent a coupling in which those two components are indirectly connected to each other by multiple nodes that fail to provide electrical continuity from one of those two components to the other. In other words, the indirect coupling can include and/or incorporate at least one additional component between those two components.

FIG. 6 is a flow diagram of an exemplary method 600 for interfacing dies that use incompatible protocols. In one example, the steps shown in FIG. 6 can be performed and/or executed during the manufacture and/or assembly of a computing device and/or system. Additionally or alternatively, the steps shown in FIG. 6 can also incorporate and/or involve various sub-steps and/or variations consistent with the descriptions provided above in connection with FIGS. 1-5.

As illustrated in FIG. 6, exemplary method 600 includes and/or involves the step of coupling a first die that uses a first protocol to a die management unit in an integrated circuit (610). Step 610 can be performed in a variety of ways, including any of those described above in connection with FIGS. 1-5. For example, an SoC manufacturer and/or subcontractor can communicatively and/or electrically couple or connect an accelerator die that uses a first protocol to a die management unit in an integrated circuit.

Exemplary method 600 also includes and/or involves the step of coupling a second die that uses a second protocol to the die management unit in the integrated circuit (620). Step 620 can be performed in a variety of ways, including any of those described above in connection with FIGS. 1-5. For example, the SoC manufacturer and/or subcontractor can communicatively and/or electrically couple or connect a host die that uses a second protocol to the die management unit in the integrated circuit.

Exemplary method 600 further includes the step of configuring the die management unit to translate at least one message between the first protocol and the second protocol to support communication between the first die and the second die (630). Step 630 can be performed in a variety of ways, including any of those described above in connection with FIGS. 1-5. For example, the SoC manufacturer and/or subcontractor can configure and/or program the die management unit to translate and/or convert at least one message between the first protocol and the second protocol to support communication between the first die and the second die.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality. Furthermore, the various steps, events, and/or features performed by such components should be considered exemplary in nature since many alternatives and/or variations can be implemented to achieve the same functionality within the scope of this disclosure.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the instant disclosure. The implementations disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An apparatus comprising:
a first die that uses a first protocol;
a second die that uses a second protocol; and
die management unit communicatively coupled to both the first die and the second die in an integrated circuit, wherein the die management unit is configured to translate at least one message between the first protocol and the second protocol to support communication between the first die and the second die.

2. The apparatus of claim 1, wherein:
the first die lacks support for the second protocol; and
the second die lacks support for the first protocol.

3. The apparatus of claim 1, wherein the second protocol comprises a Peripheral Component Interconnect Express (PCIe).

4. The apparatus of claim 1, wherein the die management unit:
receives the at least one message from the first die;
creates a compatible version of the at least one message that complies with the second protocol; and
sends the compatible version of the at least one message to the second die.

5. The apparatus of claim 4, wherein:
the second die comprises a set of system managers; and
the die management unit:
interprets contents of the at least one message; and
directs the compatible version of the at least one message to a specific manager included in the set of system managers based at least in part on the contents of the at least one message.

6. The apparatus of claim 1, wherein:
the first die experiences a fault; and
the die management unit communicatively isolates the first die from the second die, wherein the at least one message comprises a command received from the second die in an attempt to repair the first die in view of the fault.

7. The apparatus of claim 6, wherein:
the die management unit sends a translated version of the at least one message to the first die; and
the first die is unable to recover from the fault despite receiving the translated version of the at least one message.

8. The apparatus of claim 7, wherein the die management unit executes either:
a die-specific reset event that causes the first die to reset; or
a global reset event that causes the integrated circuit to reset.

9. The apparatus of claim 1, wherein the die management unit:
detects, from the second die, a request formatted in the second protocol to modify a power state of the first die;
translates the request from the second protocol to the first protocol; and
directs the first die to modify the power state based at least in part on the translated request.

10. The apparatus of claim 1, wherein the die management unit:
detects, from the second die, a request formatted in the second protocol to modify a security state of the first die;
maps the security state as identified in the request to a corresponding security state of the first die;
translates the request from the second protocol to the first protocol based at least in part on the mapping of the security state to the corresponding security state; and
directs the first die to implement the corresponding security state based at least in part on the translated request.

11. The apparatus of claim 1, wherein the die management unit:
detects a reliability, availability, and serviceability (RAS) event in connection with the first die;
translates the RAS event to a format used by the second die; and
notifies the second die of the RAS event via the format used by the second die.

12. The apparatus of claim 11, wherein the format used by the second die complies with an x86 machine check architecture.

13. The apparatus of claim 1, wherein:
the at least one message comprises a thermal control command received from the second die; and
the die management unit:
translates the thermal control command to a format used by the first die; and
directs the first die to modify a thermal setting via the format used by the first die.

14. The apparatus of claim 1, wherein the die management unit and the first die communicate via a predefined interface using a set of addressable components.

15. The apparatus of claim 1, wherein the die management unit:
directs the first die to operate in a low power state;
detects an event in connection with the second die; and
refuses to notify the first die of the event due at least in part to the event not implicating the first die.

16. The apparatus of claim 1, wherein the die management unit:
directs the first die to operate in a low power state;
detects an event in connection with the second die; and
implements a higher power state in the first die due at least in part to the event implicating the first die.

17. The apparatus of claim 1, wherein the die management unit:
requests, from the second die, an asset for use by the first die;
obtains, from the second die, the asset in response to the request; and
provides the asset to the first die.

18. The apparatus of claim 17, wherein the asset comprises at least one of:
firmware; or
a configuration.

19. A system comprising:
an integrated circuit comprising:
a first die that uses a first protocol;
a second die that uses a second protocol;
die management unit communicatively coupled to both the first die and the second die, wherein the die management unit is configured to translate at least one message between the first protocol and the second protocol to support communication between the first die and the second die; and
at least one interface communicatively coupled to the integrated circuit.

20. A method comprising:
coupling a first die that uses a first protocol to a die management unit in an integrated circuit;
coupling a second die that uses a second protocol to the die management unit in the integrated circuit; and
configuring the die management unit to translate at least one message between the first protocol and the second protocol to support communication between the first die and the second die.
